(19) United States
(12) Patent Application Publication
(10) Pub. No.: US 2012/0295073 A1
(43) Pub. Date: Nov. 22, 2012

(54) Multilayer composite for diffusion of odorous substances and production process

(76) Inventors: Benoit FRASSAINT, Mont Saint Aignan (FR); Carole Lopandia, La Madelaine De Nonancourt (FR)

(21) Appl. No.: 13/237,614

(22) Filed: Sep. 20, 2011

(30) Foreign Application Priority Data
May 20, 2011 (FR) 11/54426

(51) Int. Cl. B32B 3/00; B32B 37/14; D04H 13/00; B32B 37/02; B32B 3/26; B32B 5/00

(52) U.S. Cl. 428/195.1; 428/304.4; 428/292.1; 442/327; 156/280; 156/390

(57) ABSTRACT

A multilayer composite for diffusing an odorous substance. The composite which comprises an absorbent support-reservoir layer designed to be printed and to receive an odorous substance intended to be diffused, a printable and/or printed support layer, and a polymer barrier layer, such as a polymer film, positioned between printable and/or printed support layer and absorbent support-reservoir layer, to prevent migration of this substance between support layers.

The present invention relates to the field of odorous substance diffusers and more particularly to the field of diffusers permitting controlled and extended diffusion of the odorous substances that they contain.

It is becoming increasingly common to offer samples for a perfume in the form of a wipe impregnated and attached to a magazine advertising insert. Furthermore, it is also common to offer these samples in the form of a perfume card or blotting paper directly to potential clients in perfumeries. Likewise, to stand out from the competition, some retailers use an olfactory signature on their business cards or letters or advertising material intended for the launch of new promotional campaigns.

U.S. Pat. No. 5,093,182 offers an example of this application of a perfume with a printed advertising support. This particular application is done so that the perfume deposited on the advertising support does not interact with the ink of the printed surface. To do this, the perfume oil is previously mixed in the absence of aqueous phase with a polymer, and especially ethyl cellulose, which is a film-forming agent known to control viscosity. The perfume/polymer mixture is thus designed to be deposited on a printed support by means of a known offset device. This perfume, once deposited, has the characteristic of being able to dry quickly without requiring heating. However, such a solution is not satisfactory to the extent that the migration and/or diffusion of the perfume deposited are not controlled within the printed support or between several printed supports.

Patent application JP 9076377 also offers a process for affixing a perfume onto a sample. According to this process, a substrate receives a fragrance and then this aromatic substrate is covered with a membrane which seals the substrate. This membrane prevents early evaporation or diffusion of the fragrance deposited when the substrate is stored. The odorous substances are then released from the substrate by a user when he removes the membrane from the substrate surface. However, such a process does not offer a solution that allows directly depositing an odorous substance onto a printed substrate. Moreover, although storing the product allows preserving the odorous substance, the release of this substance remains dependent on the removal of the membrane.

Patent application US2002/0013108 describes a blotter paper having a first layer of paper or plastic with a printed outer face and a second very porous layer affixed to the inner face of the first layer by gluing or pressure and impregnated with perfume so as to diffuse a perfume by friction against the skin. This solution is not satisfactory because the perfume can freely migrate between the various layers, thus creating various technical problems and there is no provision for printing on the blotter layer.

U.S. Pat. No. 6,125,614 presents a laminated page comprising a sheet of paper support folded and sealed so as to contain a sample material located in this fold. More precisely, a barrier layer having a material impermeable to the sample material, for example a PET polymer, is affixed to the support paper sheet by an adhesive and folded with it, which gives it a first lower part and a second upper part between which the sample material is positioned. This stratified page does not allow the easy release of the sample material and requires detaching the fold. Moreover, the part receiving the sample material is not printed and the industrialization of such an invention seems complex to implement.

The present invention proposes to alleviate one or more disadvantages of the prior art, and notably to propose a solution that allows controlling the diffusion of an odorous substance by controlling its migration while preventing an alteration in its aromatic characteristics by the support materials used or by the printing processes implemented.

The present invention also proposes responding to the problems of industrial production and quality control throughout the chain of production, storage and distribution of the product.

This objective is attained by means of a multilayer composite for diffusion of an odorous substance, characterized in that the multilayer composite comprises:
an absorbent support-reservoir layer designed to be printed and to receive an odorous substance intended to be diffused,
a printable and/or printed support layer,
a polymer barrier layer positioned between the printable and/or printed support layer and the absorbent support-reservoir layer, to prevent migration of this substance between the supports.

According to a special feature of the invention, the multilayer composite for diffusing an odorous substance is characterized in that the printable and/or printed support layer is made of cellulose fibers.

According to another special feature of the invention, the multilayer composite for diffusing an odorous substance is characterized in that the absorbent support-reservoir layer for the odorous substance is created by at least one cloth and/or at least one polymer of synthetic fibers.

According to another special feature of the invention, the multilayer composite for diffusing an odorous substance is characterized in that the synthetic fiber polymer is nonwoven.

According to another special feature of the invention, the nonwoven polymer is a polyester.

According to another non-limiting special feature of the invention, the multilayer composite for diffusing an odorous substance is characterized in that the nonwoven polyester has undergone a step of embossing its surface by graining, stamping and/or embossing.

According to another special feature of the invention, the multilayer composite for diffusing an odorous substance is characterized in that the polymer barrier layer between the absorbent support-reservoir layer and the printable and/or printed support layer forms a first migration barrier, called internal, the multilayer composite also comprising another barrier layer positioned on a second face of the printable and/or printed support layer forming a second migration barrier called external.

According to another special feature of the invention, the multilayer composite for diffusing an odorous substance is characterized in that the composite also has at least one hinge axis to allow covering a first part of the outer face of the absorbent support-reservoir layer which is not in contact with the polymer barrier layer on a second part of this outer face of the absorbent support-reservoir layer.

In a non-limiting manner, according to another special feature of the invention, the multilayer composite for diffusing an odorous substance is characterized in that the odorous substance deposited on the absorbent support-reservoir layer is composed of at least one essential oil.

Another objective of the invention is to propose a process for producing a multilayer composite of the invention.

This objective is attained by means of a production process for a multilayer composite for diffusion of an odorous substance according to the invention, characterized in that the multilayer composite particularly comprises:
a step of affixing a polymer barrier layer, such as a polymer film, by one of its faces, onto a coating forming an absorbent support-reservoir layer, so as to create an absorbent support-reservoir layer/polymer barrier layer complex,
a step of affixing a printable and/or printed support layer onto the face of the polymer barrier layer which is not in contact with the absorbent support-reservoir layer.
a step of depositing an odorous substance onto the coating forming the absorbent support-reservoir layer.

According to a special feature of the invention, the production process for a multilayer composite is characterized in that the process comprises, prior to the step of depositing the odorous substance, a step of printing on the surface of the printable support layer and/or the absorbent support-reservoir layer which is not in contact with the polymer barrier layer.

According to another special feature of the invention, the production process for a multilayer composite is characterized in that the printing step is done with at least one ink compatible with the odorous substance deposited on the support-reservoir layer.

According to another non-limiting special feature of the invention, the production process for a multilayer composite is characterized in that the process also comprises a step of embossing the support-reservoir face of the complex formed by at least the absorbent support-reservoir layer/polymer barrier layer assembly.

According to another special feature of the invention, the production process for a multilayer composite is characterized in that the step of depositing an odorous substance is done by spreading this substance over a defined surface of the absorbent support-reservoir layer.

According to another special feature of the invention, the production process for a multilayer composite is characterized in that the process also comprises a step of affixing an external barrier layer onto the face of the printable and/or printed support layer not oriented toward the polymer barrier layer.

According to another special feature of the invention, the production process for a multilayer composite is characterized in that the process comprises at least one step of finishing the multilayer composite according to a predefined format.

According to another special feature of the invention, the production process is characterized in that that the process also comprises at least step of folding the composite so that a first part of the outer face of the absorbent support-reservoir layer not oriented toward the polymer barrier layer covers a second part of this same outer face of the absorbent support-reservoir layer.

Another objective of the invention is to propose a system for implementing the production process for the multilayer composite of the invention.

This objective is attained by means of a production system for a multilayer composite for diffusion of an odorous substance characterized in that it is designed to implement a production process according to the invention, the system particularly comprising:
a station for affixing a printable and/printed support layer onto the face of the polymer barrier layer which is not in contact with the absorbent support-reservoir layer, this affixing station receiving a two-layer complex including the absorbent support-reservoir layer onto which the polymer barrier layer has been previously affixed,
a station for depositing an odorous substance onto an absorbent support-reservoir layer.

According to one special feature of the invention, the production system for a multilayer composite for diffusing an odorous substance is characterized in that the system notably comprises, upstream of the affixing station for the printable and/or printed support layer, a station for affixing a polymer barrier layer, by one of its faces, onto a layer forming the support-reservoir, so as to create an absorbent support-reservoir layer/polymer barrier layer complex.

According to one non-limiting special feature of the invention, the production system for a multilayer composite for diffusing an odorous substance is characterized in that the system comprises a station for printing a pattern onto one of the faces of the absorbent support-reservoir layer and/or the printable support layer.

According to another special feature of the invention, the production system also comprises a post for affixing an external barrier layer onto the face of the printable and/or printed support layer not oriented toward the absorbent support-reservoir layer of the composite.

According to another special feature of the invention, the production system for a multilayer composite for diffusing an odorous substance is characterized in that the system comprises at least one station for finishing the multilayer composite according to a predefined format.

According to another special feature of the invention, the production system comprises a station for folding the composite permitting a first part of the outer face of the absorbent support-reservoir layer which is not in contact with the polymer barrier layer to cover a second part of this same outer face of the absorbent support-reservoir layer which is not in contact with the polymer barrier layer.

According to another special feature of the invention, the production system for a multilayer composite for diffusing an odorous substance is characterized in that the at least one production station is controlled by a central unit.

The invention with its characteristics and advantages will appear more clearly upon reading the description made in reference to the attached drawings in which:

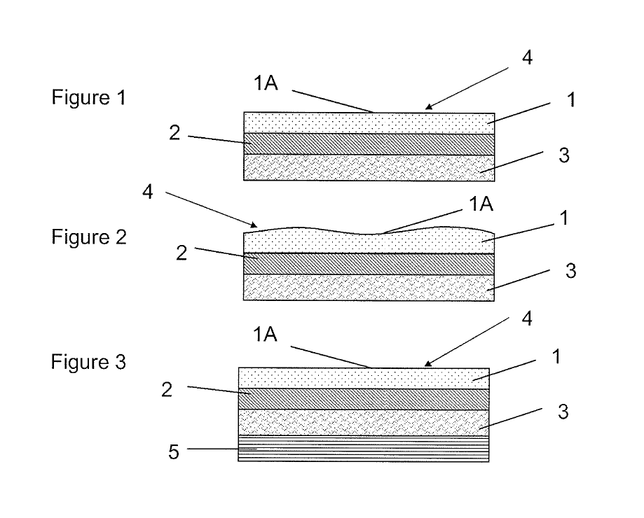

FIG. 1 schematically represents a superimposition of the various layers of the composite according to the invention permitting receiving an odorous substance in an absorbent support-reservoir layer,

FIG. 2 schematically represents a variant of the composite in which the absorbent reservoir-support layer has an embossing,

FIG. 3 schematically represents a variant of the composite in which an external barrier layer is affixed to the face of the printable and/or printed support layer not bound to the polymer barrier layer.

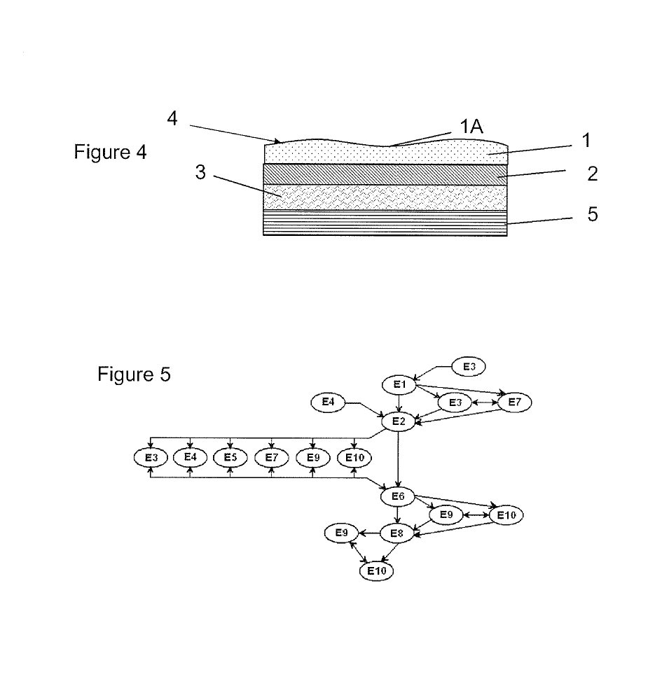

FIG. 4 schematically represents a variant of the composite in which an absorbent support-reservoir layer has an embossing and in which an external barrier layer is affixed to the face of the printable and/or printed support layer not bound to the polymer barrier layer.

FIG. 5 shows a diagram of the various possible steps of a production process for the composite of the invention,

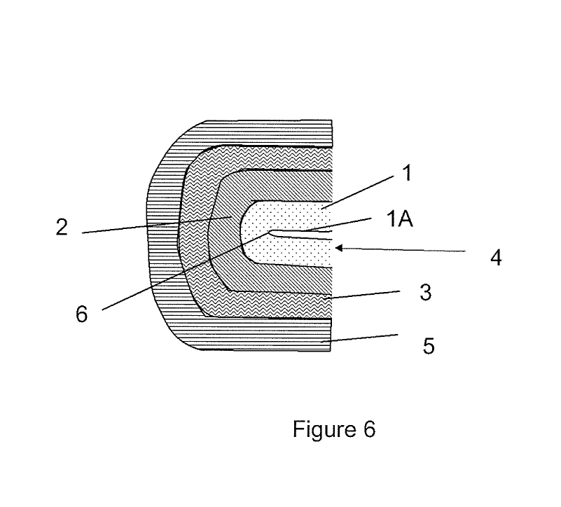

FIG. 6 schematically represents a variant of the multilayer composite according to the invention in which it is folded to prevent the diffusion of the odorous substance,

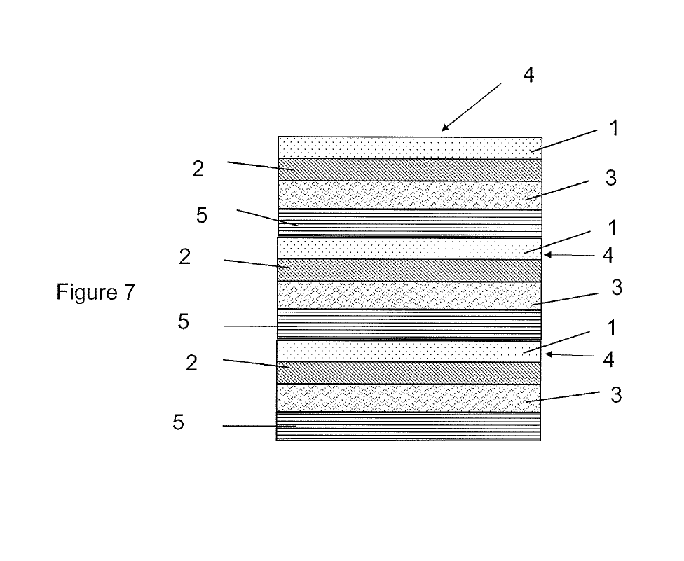

FIG. 7 illustrates a stack of multilayer composites during transport and/or storage, before folding and

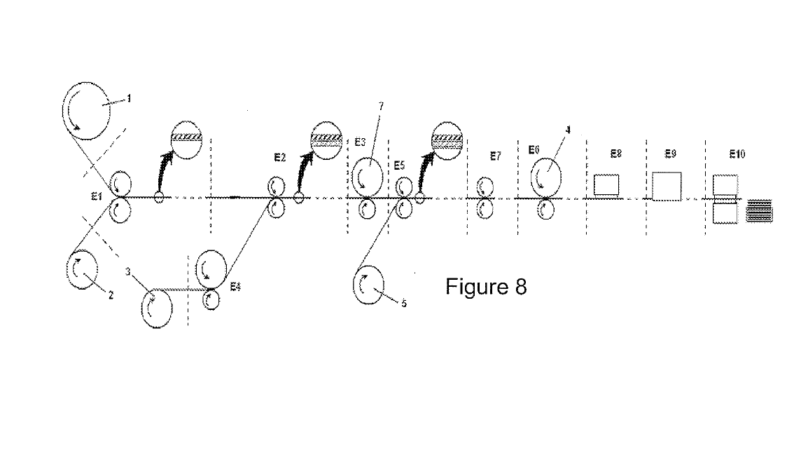

FIG. 8 shows a schematic example of a system for implementing the production process according to the invention.

The composite of the invention is made by a superimposed multilayer assembly arranged to receive and store or trap an odorous substance (4) during storage and during the various steps of industrial production or during the distribution of the products, and to permit its diffusion when the brochure is opened by the final recipient (magazine or correspondence reader, boutique client, etc.)

This multilayer assembly is particularly suited, for a non-limiting example, to perfume printed media used in numerous industries, notably the packaging and cosmetic industries (manufactures of cases, boxes and sample cards), POSA (point-of-sale advertising) and printing (press inserts, directed or undirected advertising, flyers, or olfactory marketing).

In particular, it is designed to create advertising inserts or sample cards to be inserted into the pages of a journal or magazine and diffuse fragrances associated with a visual product communication printed on the insert or sample card.

The odorous substance (4) is volatile and can be a perfume, an essential oil, alone or combined with a solvent, an aromatic substance, a diluent, a polymer or even a resin.

Odorous substance (4) is formulated in an oil, cream or gel liquid or paste phase, of a suitable viscosity so that odorous substance (4) can be deposited into or onto absorbent support-reservoir layer (1).

According to one preferred embodiment, this odorous substance (4) covers at least a part of the surface of the absorbent support-reservoir layer of the multilayer assembly, by the deposition of a predefined quantity. This deposition can be done by coating all or part of absorbent support-reservoir layer (1) of the composite.

Preferentially, this odorous substance (4) is deposited in the liquid phase.

According to one embodiment, odorous substance (4) can be integrated by moistening and/or impregnation in absorbent support-reservoir layer (1) thus permitting storing and diffusing odorous substance (4).

As illustrated in FIGS. 1 to 4, absorbent support-reservoir layer (1) is affixed on one of its faces to a polymer barrier layer (2), formed, for a preferential example, by a polymer film, which provides a migration barrier for odorous substance (4) between absorbent support-reservoir layer (1) and printable and/or printed support layer (3). Polymer barrier layer (2) is thus positioned interspersed between the two layers (1) and (3).

This polymer barrier layer (2) formed by a polymer can also use a PET or OPP type polymer film, in a non-limiting manner. Thus positioned, this polymer barrier layer (2) prevents any migration of odorous substance (4) from absorbent support-reservoir layer (1) to printable and/or printed support layer (3).

For example, in a non-limiting manner, OPP polymer barrier layer (2) has a thickness of 15 μm and a weight of approximately 13 g/m² and PET polymer barrier layer (2) has a weight of approximately 17 g/m².

The second printable and/or printed support layer (3) can be formed by cellulose fiber, or any other type of support that can be printed. This layer (3) can thus also refer to paper or cardboard in its various forms, i.e., from cellulose fibers, rather than polyester in its various forms.

For example, in a non-limiting manner, support layer (3) has a weight of 100 g/m² to 300 g/m².

In the scope of the invention, absorbent support-reservoir layer (1) is preferentially made from cloth and/or at least one synthetic fiber polymer.

This woven or non-woven polymer of synthetic fibers, such as a polyester, does not interact on contact with odorous substance (4) and permits automatic cutting with hot knives devices such as used in film coating or laminating.

Advantageously, it is a non-woven polymer such as a non-woven polyester fiber, for example, in a non-limiting manner, having a density of 50 to 120 g/m².

This non-woven polyester is inert, because the fibers are synthetic, which allows it not to be oxidized by odorous substance (4).

Remarkably, with such a nonwoven polyester, and due to the entanglement of the nonwoven fibers, the diffusion of odorous substance (4) can be from around a few days to several weeks in open air according to the quantity deposited and according to the formulation of odorous substance (4).

However, this embodiment is not limiting of the invention; the absorbent support-reservoir layer can be formed of any material that can store and release an odorous substance, which also includes fibers of cellulose, cellulose acetates, and/or other polymers.

As illustrated in FIGS. 2 and 4, absorbent support-reservoir layer (1) is deformable and can undergo an embossing operation to modify the state of its surface (1A).

This operation can be done by one or more steps of graining and/or embossing and/or stamping. In this way, a particular appearance and feel of the surface of absorbent support-reservoir layer (1) can be obtained.

Moreover, although this characteristic is not limiting of the invention, the material used to form absorbent support-reservoir layer (1) is preferably designed to be printed.

In this case, inks compatible with odorous substance (4) should be used so that these inks do not interact with or alter the olfactory characteristics of odorous substance (4). According to a preferred but non-limiting embodiment of the invention, the printing inks used are of the UV type and are hardened by photopolymerization during linking by UV (ultraviolet) radiation. The inks can also be dried by IR (infrared) radiation.

According to a variant in the embodiment of the invention illustrated in FIGS. 3 and 4, the multilayer composite also has an external barrier layer (5) on the surface of printable and/or printed support layer (3) which is not in contact with polymer barrier layer (2).

According to a special feature of embodiment that does not limit the invention, external barrier layer (5) is made by a treated polypropylene film.

The polypropylene film can be treated by a plasma treatment that allows depositing and/or activating certain groups of at least one of the compounds that forms the surface of external barrier layer (5).

In an alternative embodiment, the polypropylene layer is treated chemically.

According to a variant in the embodiment of the invention, external barrier layer (5) can be formed by a varnish deposited on the surface of printable and/or printed support layer (3) which is not in contact with polymer barrier layer (2). This varnish may, for example, be hardened by UV photopolymerization.

Advantageously, this external barrier layer (5) prevents the migration and diffusion of odorous substances (4) into printable and/or printed support layer (3) from absorbent support-reservoir layer (1) of a first multilayer composite positioned under a second multilayer composite, in particular during stacking, storage and transport of a plurality of multilayer composites of the invention, as illustrated in FIG. 7. The last two support-reservoir layers (1) at the end of the stack can be positioned head to tail with regard to one another, i.e., in contact with one another at their outer face (1A), which prevents or limits the diffusion of odorous substance (4) due to the impermeability of sealing polymer barrier layer (2) located at the end of the stack.

This external barrier layer (5) can, for example, according to its characteristics, have a multilayer composite surface of the invention which can be glued to a support. This external barrier layer (5) can then be glued and allow affixing the multilayer composite onto a support such as, for example and in a non-limiting manner, a magazine or advertising element, or even a POSA (point-of-sales advertising) presentation element.

In one alternative embodiment, compatible with external barrier layer (5) and illustrated in FIG. 6, the multilayer composite of the invention also has at least one hinge axis (6) to allow covering a first part of outer face (1A) of first absorbent support-reservoir layer (1) which is not in contact with polymer layer (2) on a second part of this same outer face (1A). All the layers (absorbent support-reservoir layer (1), polymer barrier layer (2), printed and/or printable support layer (3) and external barrier layer (5) are folded together.

This hinge axis (6) can be made, for example by axial creasing or bending. Thus, when absorbent support-reservoir layer (1) contains an odorous substance (4), covering by folding one over the other of the two parts of the face of absorbent support-reservoir (1) into a closed position limits or even stops the diffusion of odorous substance (4).

The user then releases odorous substance (4) by diffusion, by opening and/or unfolding the multilayer composite of the invention (opening the magazine, opening the sample card, opening a direct marketing brochure, etc.).

Thus, the multilayer composite of the invention creates a support for the diffusion of an odorous substance (4) which can be associated with a printed visual communication element (text, trademark, advertising message, etc.) both on the part formed by printable layer (3) and on the part formed by absorbent support-reservoir layer (1).

Also, the multilayer composite of the invention allows adding an effect of a particular feel on the part formed by absorbent support-reservoir layer (1) given the fibrous texture of the absorbent support reservoir layer and given that one or more embossing steps have been done (graining, embossing, stamping, etc.).

Thus formed, absorbent support-reservoir layer (1) awakens three senses, smell, vision and touch.

The production of this multilayer composite of the invention requires successive steps in a production process illustrated in FIGS. 5 to 8, and some of whose order may differ.

Thus, the production process for the multilayer composite of the invention notably comprises:
a step (E1) of affixing a polymer barrier layer (2) by one of its faces onto the coating forming an absorbent support-reservoir layer (1) designed to receive an odorous substance (4) to be diffused, so as to create an absorbent support-reservoir layer/polymer barrier layer bilayer complex,
a step (E2) of affixing a printable and/or printed support layer (3) onto the face of polymer barrier layer (2) which is not in contact with absorbent support-reservoir layer (1),
a step (E6) of depositing an odorous substance (4) onto absorbent support-reservoir layer (1).

Step (E1) of affixing absorbent support-reservoir layer (1) onto polymer barrier layer (2) is done by backing and/or laminating.

Step (E2) of affixing printable and/or printed support layer (3) onto polymer barrier layer (2) is done by laminating, complexing, film coating or gluing.

Deposition step (E6) can be done by coating, printing and/or impregnation of the surface of absorbent support-reservoir layer (1) by odorous substance (4) designed to be diffused. This deposition step can use screen printing, flexography or offset printing techniques. These techniques allow distributing odorous substance (4) over all or part of the surface of absorbent support-reservoir layer (1) and permit varying the quantity of odorous substance (4) deposited.

During the production of the multilayer composite, as illustrated in FIGS. 5 and 8, it may be necessary to make a print (E3) on the surface of absorbent support-reservoir layer (1) by an appropriate printing device (7). This print (E3) can be done either before step (E1) of affixing polymer barrier layer (2) onto absorbent support-reservoir layer (1), or after this step, but preferably before step (E6) of depositing odorous substance (4) on absorbent support-reservoir layer (1).

Likewise, the process may include a printing step (E4) of printable support (3) by an appropriate printing device and/or system. This printing step (E4) is preferably done before step (E6) of depositing odorous substance (4) on absorbent support-reservoir layer (1). According to the type of process sought, this printing step (E4) can be done either once printable support layer (3) is affixed onto the face of polymer barrier layer (2) which is not in contact with absorbent support-reservoir layer (1), or prior to this affixing step (E2).

Likewise, before step (E6) of depositing odorous substance (4) onto absorbent support-reservoir layer (1), the process may include a step (E5) of affixing an external barrier layer (5) on the second face of printable and/or printed support (3).

Also, before deposition step (E6), as illustrated in FIGS. 5 and 8, the process may include an embossing step (E7) by graining, stamping or embossing of the entire multilayer composite or only one or more assembled layers of the composite.

Once the multilayer composite is created and odorous substance (4) possibly deposited (E6), the process can also include a finishing step (E8). This finishing step (E8) consists of one or more operations from a list including, for example, gilding, cutting, scoring.

According to a first particular embodiment which is not limiting of the principle of the invention, the homogeneity of distribution and determination of the surface intended to be covered by odorous substance (4) is defined by a screen forming a variable mesh screen (principle similar to the screen printing technique). For a non-limiting example, it is possible to deposit a quantity of odorous substance from 12 to 20 g/m² by this process.

According to a second particular embodiment which is not limiting of the principle of the invention, the homogeneity of distribution can also make use of an anilox, which is a cylinder having on its peripheral surface different types of engravings or cells which, in their respective shapes and volumes and in combination with a blanket, take part in determining the amount of odorous substance (4) intended to be deposited on absorbent support-reservoir layer (1) (principle similar to the flexography printing technique). For a non-limiting example, it is possible to deposit a quantity of odorous substance (4) from 3 to 10 g/m² by this process.

According to a third particular embodiment, a metal surface forming, for example, a plate is used to transfer odorous substance (4) onto an elastomer surface forming a blanket, for example. The elastomeric surface is positioned in contact with the surface of support-reservoir absorbent layer (1) (principle similar to the offset printing technique). For a non-limiting example, it is possible to deposit a quantity of odorous substance (4) of around one or a few g/m² by this process.

Once the multilayer composite is created and possibly printed, and odorous substance (4) is deposited, the system of the invention also permits transporting and storing a multilayer composite in the form of stacked sheets or flats, so that diffusion or migration of odorous substance (4) is controlled.

According to another preferred embodiment, the process of the invention also has a step (E10) of folding the composite so that a first part of outer face (1A) of absorbent support-reservoir layer (1) which is not in contact with polymer barrier layer (2) covers a second part of this same outer face (1A) of absorbent support reservoir layer (1). Preferentially, this folding operation (E10) is done after deposition step (E6) of odorous substance (4) on the composite. Possibly, step (E6) of depositing odorous substance (4) on absorbent support-reservoir layer (1) can be done after all the other production steps at a point of sales during distribution or final presentation of the multilayer to the client.

Furthermore, the production system, permitting implementing the process of the invention, can be formed by a single set-up or multiple set-ups separated from one another. These set-ups then have one or more stations arranged to perform at least one of the various operations or steps of the production process for the multilayer composite of the invention.

According to one particular embodiment that is not limiting of the invention illustrated in FIG. 8, the system of the invention includes several stations, each designed to perform at least one of the following steps: affixing the layers together (E1, E2, E5), printing (E3, E4), deposition of the odorous substance (E6), embossing (E7) or finishing (E8) of the production process of the invention.

According to a preferred embodiment that is not limiting of the invention, the set-up also includes a central unit that coordinates the operation of the various stations of the system. This coordination can also simply concern two stations as well as all the stations of the system; the central unit can control at least one station of the set-up.

According to one particular embodiment, the production system can make use of several reels, each of which corresponds to a roll of one of the layers of the multilayer composite before it is integrated into the composite of the invention.

The system of the invention permits unwinding (or unrolling) these reels arranged to allow conducting the various successive steps of the process. Thus the reels of absorbent support-reservoir layer (1) and polymer barrier layer (2) are unwound first in order to permit them to be affixed (E1) at a common surface. Then, the reel of printable and/or printed support layer (3) is unwound to permit it to be affixed (E2) onto the face of polymer barrier layer (2) not oriented toward absorbent support-reservoir layer (1). Likewise, according to the desired type of composite, a reel containing the coating intended to form external barrier layer (5) is also unwound to cover the face of printable and/or printed support layer (3) located on the face not oriented toward polymer barrier layer (2).

As illustrated in FIG. 8, since the system makes use of reels, the presence of at least one cutting station is indispensable to ensure formatting (E9) of the multilayer composite according to a desired format. This cutting (E9) of the strip of partially or totally formed composite can make use of a straight cutting blade in order to obtain several stackable pieces of composites called flats or sheets.

Alternatively, this straight blade can be replaced by a punch for a cutting the composite strip into a defined format.

Likewise, according to the composition forming the multilayer composite of the invention, the blade used can be a straight thermal blade that allows cleanly and quickly cutting the composite by melting while avoiding the undesirable presence of fibers that could detach from the composite and create technical problems during the printing process. The composites cut to the desired format are then collected and arranged in the form of flats or sheets manually or by an automatic collecting device.

As described previously, FIG. 5 that provides a schematic representation of the different stages of the production process of the composite of the invention clearly shows that some process steps, especially the steps of printing (E3, E4), embossing (E7) or even cutting (E9) can be carried out at different times of the process compared to the main steps of forming bi-layer (E1) and then tri-layer (E2) of the composite and the deposition (E6) of the odorous substance of the composite

The system for implementing the process of the invention comprises a plurality of stations, each of which is organized, arranged or designed to conduct respectively at least one process step of the invention previously described. According to one non-limiting embodiment of the invention, the stations of the system for implementing the process of the invention can be positioned on one or more different production sites. The products obtained at each of these stations can then be transported from one site to another so that the process can continue to be implemented. Likewise, the system of the invention can integrate a central unit that manages and coordinates at least two stations of the system in the production of the composite.

It should be obvious for those skilled in the art that the present invention allows embodiments in numerous other specific forms without departing from the scope of the invention as claimed. Consequently, the present embodiments should be considered illustrations, but can be modified within the field defined by the scope of the attached claims.

1. Multilayer composite for diffusing an odorous substance, the multilayer composite comprising:
an absorbent support-reservoir layer designed to be printed and to receive an odorous substance intended to be diffused;
a printable and/or printed support layer; and
a polymer barrier layer positioned between printable and/or printed support layer and absorbent support-reservoir layer, to prevent migration of odorous substance between support layers.

2. Multilayer composite according to claim 1, wherein the printable and/or printed support layer is of cellulose fibers.

3. Multilayer composite according to claim 1, wherein the polymer barrier layer is a PET or OPP polymer film.

4. Multilayer composite according to claim 1, wherein the absorbent support-reservoir layer for odorous substance is made by at least one cloth and/or at least one polymer of synthetic fibers.

5. Multilayer composite according to claim 4, wherein the the synthetic fiber polymer of absorbent support-reservoir layer is nonwoven.

6. Multilayer composite according to claim 5, wherein the synthetic fiber polymer of absorbent support-reservoir layer is a nonwoven polyester.

7. Multilayer composite according to claim 1, wherein the polymer barrier layer between absorbent support-reservoir layer and printable and/or printed support layer form a first migration barrier, called internal, the multilayer composite also comprising an external barrier layer positioned on a second face of printable and/or printed support layer forming a second migration barrier called external.

8. Multilayer composite according to claim 1, wherein the odorous substance deposited on absorbent support-reservoir layer is made up of at least one essential oil.

9. Multilayer composite according to claim 1, further comprising at least one hinging axis to allow covering a first part of outer face of absorbent support-reservoir layer which is not in contact with polymer barrier layer on a second part of this same outer face of absorbent support-reservoir layer.

10. Production process for a multilayer composite for diffusion of an odorous substance according to claim 1, the process comprises:
affixing a polymer barrier layer by one of its faces onto a coating forming an absorbent support-reservoir layer, so as to create an absorbent support reservoir layer/polymer barrier layer complex;
affixing a printable and/or printed support layer onto the face of polymer barrier layer which is not in contact with support reservoir absorbent layer; and
depositing an odorous substance onto the coating forming absorbent support-reservoir layer.

11. Production process according to claim 10, wherein the process further comprises, prior to the depositing step, printing on the surface of printable and/or printed support layer and/or the surface of absorbent support-reservoir layer (1) which is not in contact with polymer barrier layer.

12. Production process according to claim 10, further comprising affixing an external barrier layer onto the face of printable and/or printed support layer not oriented toward absorbent support-reservoir layer of the composite.

13. Production process according to claim 10, wherein the depositing an odorous substance is done by spreading the substance over a defined surface of absorbent support-reservoir layer.

14. Production process according to claim 10, the process further comprising folding the composite so that a first part of outer face of absorbent support-reservoir layer which is not in contact with polymer barrier layer covers a second part of this same outer face.

15. Production system for a multilayer composite for diffusion of an odorous substance wherein the system is designed to implement the production process according to claim 10, the system comprising:
a station for affixing a printable and/printed support layer onto the face of polymer barrier layer which is not in contact with absorbent support-reservoir layer, this affixing station receiving a composite formed by a two-layer complex including absorbent support-reservoir layer onto which is affixed polymer barrier layer; and
a station for depositing an odorous substance onto absorbent support-reservoir layer.
